(19) United States
(12) Patent Application Publication
(10) Pub. No.: US 2009/0099776 A1
(43) Pub. Date: Apr. 16, 2009

(54) SYSTEM AND METHOD FOR SUGARCANE YIELD ESTIMATION

(76) Inventors: Mangesh D. Kapadi, Bangalore (IN); Jinendra K. Gugaliya, Bangalore (IN); Lingathurai Palanisamy, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 11/872,999

(22) Filed: Oct. 16, 2007

(51) Int. Cl. G06F 19/00; G01W 1/00

(52) U.S. Cl. 702/3; 702/2

(57) ABSTRACT

A combination of yield prediction models is usable to predict the yield of a crop, such as sugarcane, from land. The model combination includes at least first and/or second models. The first model may be a structured or unstructured model that models season dependent effects on yield. If structured, the first model may be a linear, non-linear, or polynomial representation. The second model may be a structured or unstructured model that models age dependent effects on yield. If structured, the second model may be a linear, non-linear, or polynomial representation. Additional models that model weather and/or soil dependent effects on yield may also be used in the model combination.

### TECHNICAL FIELD

A method and/or apparatus is disclosed herein for estimating yield of a crop, such as sugarcane, from a given area, such as an acre, of land.

### BACKGROUND

Sugarcane is a member of the grass family and is valued chiefly for the juices (especially sucrose) that can be extracted from its stems. The raw sugar that is produced from these juices is later refined into white granular sugar.

Sugarcane, which is the raw material for the production of sugar, is a perennial crop. One planting of sugarcane generally results in three to six annual harvests before replanting is necessary. The very first harvest after the planting is called “Plant Cane,” while the subsequent harvests before the next replanting are called “Stubble” or “Ratoon.” The first stubble or ratoon is the first harvest following the plant cane harvest, the second stubble or ratoon is the second harvest following the plant cane harvest, and so on.

As a sugarcane plant matures throughout the growing season, the weight of total sugarcane per acre increases. The production and health of a sugarcane crop depends on several factors, which vary seasonally as well as annually, and the interactions among these factors are very complex.

A typical sugar industry buys sugarcane from various farmers, and the farmers have a contract with sugar industries. Each sugar industry knows the planting date of each crop along with the plant variety for every farm. The farmers are paid based on the weight and quality of the sugarcane harvested from an individual field.

The amount of sugarcane per unit area (e.g., acre) is called yield. The yield of sugarcane depends on various factors such as plant variety (also called as cultivar), maturity (age from the date of planting for plant cane or from the date of last harvest for ratoon) of the sugarcane, weather conditions, soil conditions, diseases, harvesting conditions, and the amount of trash incorporated into the harvested sugarcane. This trash can be defined as the amount or quantity of leaves, tops, dead stalks, roots, soil, etc. delivered together with sugarcane.

The long-term viability of the sugar industry depends upon finding ways to produce sugar more economically through production management decisions which can reduce production costs and/or increase returns. Harvest scheduling, deciding when to harvest which sugarcane variety (or cultivar) of what age, is one such practice which has a direct impact on net farm returns. The net farm return is the total sugar (in weight) obtained from a given planting.

In this application, a methodology for predicting sugarcane yield is presented. The modeling of sugarcane yield captures the dynamic effects of vegetative growth (which depends on variety, age, weather conditions, soil condition, farming practices, etc.) during growing and harvesting seasons. This model can then be used to determine when specific sugarcane farms should be harvested in order to maximize the sugarcane yield so as to help improve net farm returns.

Yield, which is the amount of sugarcane that is harvested from the fields, is distinguished from recovery, which is the amount of sugar that is recovered from the sugarcane. A methodology has been developed in co-pending U.S. patent application Ser. No. 11/445,053 filed on Jun. 1, 2006 for the estimation of sugar recovery (e.g., amount of sugar in sugarcane). The estimation of recovery can be used along with estimated yield values to assist in daily harvest scheduling at the individual farm level so as to maximize total farm net returns.

As indicated above, sugarcane yield (the amount of sugarcane that can be harvested from a field) is affected by a combination of deterministic parameters (e.g., variety, age, season) and stochastic parameters (e.g., weather conditions and soil type, farming practices etc.). Hence, modeling of the sugarcane yield is a complex task.

A method is disclosed herein to estimate sugarcane yield in a systematic way. When the nature of the relationship between the individual parameters (like yield and sugarcane age or yield and season) is known a priori, then modeling can be achieved using compact structured representation. However, in some practical scenarios, the nature of this relationship may not be known a priori. In these latter scenarios, modeling can be achieved using unstructured (non-parsimonious) models. Based on the situation and information at hand, either or both of the models can be used for yield prediction. Both of these approaches are discussed below in detail.

### BRIEF DESCRIPTION OF THE DRAWINGS

Features, aspects, and advantages of the present invention will become better understood when the following detailed description is read with reference to the accompanying drawings in which:

FIG. 1 illustrates an example of overall yearly distribution of a harvest load (amount of sugarcane) as a function of harvest month as indicated by a training set of example data;

FIG. 2 illustrates overall yearly distribution of a harvest load (amount of sugarcane) as a function of age as indicated by the training set of example data;

FIG. 3 illustrates usage of different sugarcane varieties that produced the training set of example data;

FIG. 4 is a flow chart representing an example of a program that can be executed by a computer for generating a sugarcane yield prediction model;

FIG. 5 is a flow chart representing an example of another program that can be executed by a computer for generating a sugarcane yield prediction model;

FIG. 6 is a flow chart representing a program that can be executed by a computer for predicting sugarcane yield; and,

FIG. 7 illustrates a computer as an example mechanism for executing the program of FIG. 4 and/or FIG. 5 and/or FIG. 6.

### DETAILED DESCRIPTION

Yield prediction may, for example, involve a training stage and a use stage. During the training stage, a model for yield prediction is generated, values for the parameters of the model are determined based on training data, and the values are inserted for the parameters in the model to complete the yield prediction model. Model generation and parameter value determination are based on equations (1)-(48) described below. During the use stage, the completed crop yield prediction model is used to predict the yield of a crop such as sugarcane.

As an example, a sample sugar processing facility may have two harvest seasons in a year. The first (or Main) season can be from December to July, while the second (or Special) season can run from August to October. In this example, the harvest data (training data) of both seasons from the few years can be used to find the relationship between sugarcane yield, age at harvest, seasonal effects, variety, crop class or ratoon number, weather conditions, and/or soil type.

A representative set of a portion of the training data for this example over the last few years is shown in the following table.

| | | | | | | | Net | |
|---|---|---|---|---|---|---|---|---|
| | | | | | | | Plot | |
| Season | Plot | | Ratoon | Zone | Planting | Harvest | Area | Weight |
| Code | Number | Variety | Number | Code | Date | Date | (acre) | (ton) |
| Year1 M | KB766 | 02 | P | Zone 1 | Year0 | Year1 | 5 | 245.5 |
| | | | | | 01/20 | 02/16 | | |
| Year1 M | PC005 | 02 | R1 | Zone 5 | Year0 | Year1 | 3 | 150.5 |
| | | | | | 02/10 | 03/10 | | |
| Year1 M | LA103 | 01 | R2 | Zone 3 | Year1 | Year2 | 0.4 | 15.9 |
| | | | | | 08/18 | 09/15 | | |

The planting regions can be classified into different zones based on weather and soil conditions. The difference between the planting date and the harvest date indicates the sugarcane age at the time of harvest. The ratoon code P indicates Plant Cane, while the ratoon code R represents the ratoon after first harvest. Net plot area indicates the harvested area of the farm, while weight indicates the actual weight of the sugarcane harvested from the net farm area. In the main and special seasons over the last few years, there are many entries similar to those shown in the above table.

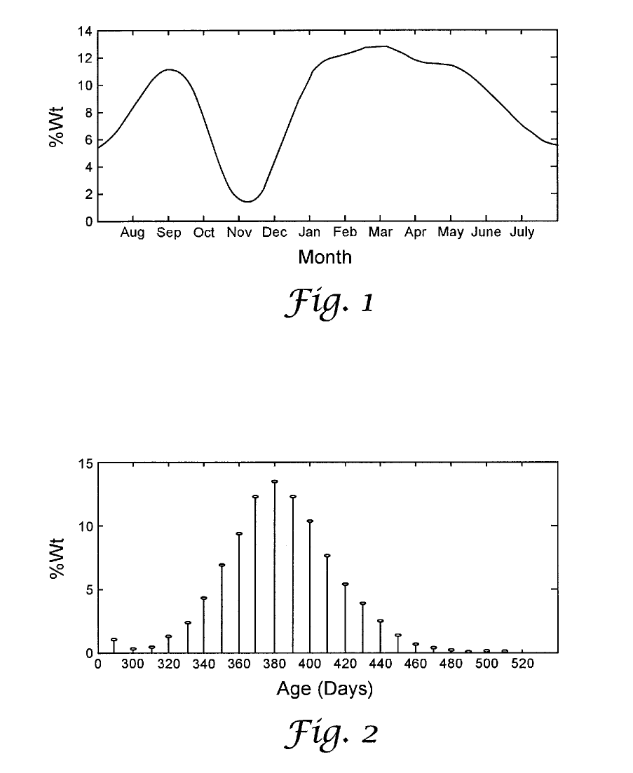

The overall yearly distribution (considering the last few years of harvest data) of the harvest load (weight percent-age) as a function of harvest month is plotted in FIG. 1. It can be seen from FIG. 1 that the maximum load is harvested in the months of February and March, while November and December are the least harvested months. Typical harvest ages are 300 to 520 days. Ages less than 300 or more than 520 are generally considered as outliers. Those harvests of sugarcane less than 300 days are mostly used for planting. However, whatever remains after planting is generally sent to the factory for crushing instead of considering it as loss. Similarly sugarcane loads with an age more than 520 are last harvest season loads that were not harvested in that season (such as caused by weather problems). Hence, they become very old loads for the current harvest season.

With this information in hand, the sugarcane loads may be classified in a number (such as 23 as shown in FIG. 2) of different age groups. The first age group is for all those loads with an age less than 300, while the last age group is for those having an age greater than 520. All the other age groups have age ranges, for example, of 10 days. It is assumed that the sugarcane yield in 10 day time periods does not vary significantly and, hence, can be safely considered as constant.

It can be seen from the age distribution diagram of FIG. 2 that most of the harvested sugarcane loads belong to age groups ranging from 6 to 16, with peak loads belonging to age groups 9, 10 and 11. The sugarcane loads coming to factory are mostly in the age range of 360 to 410 days.

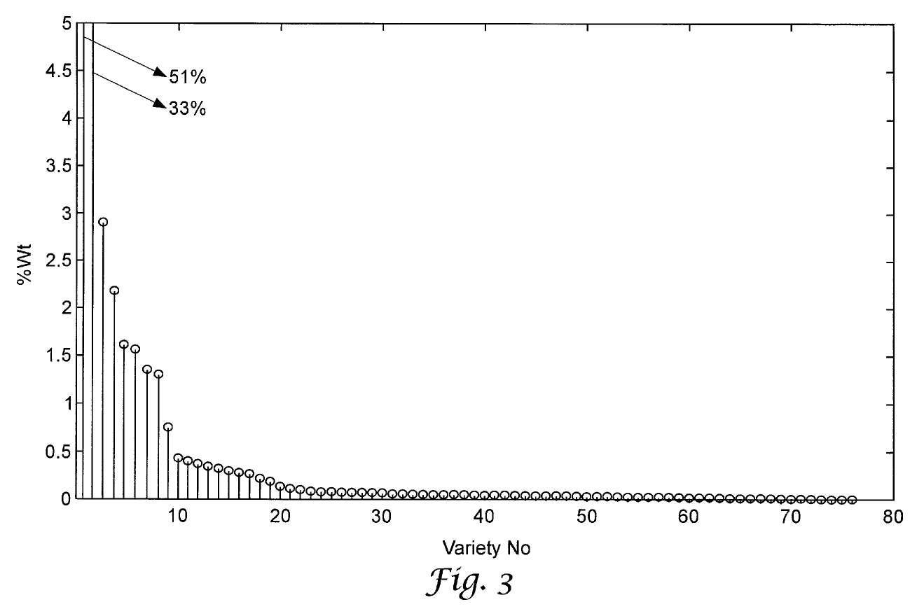

The example training data may indicate a usage of different sugarcane varieties as shown in FIG. 3, which illustrates the weight percentage contributed by each variety during harvesting over a number of years. As shown in FIG. 3, even though many distinct varieties were harvested, there were only a limited number of varieties whose cumulative contribution was significant (such as 95% of the total weight of all varieties). The remaining varieties contributed less significantly (such as 5% by weight). These latter varieties may be either research varieties or varieties which were innovated in the past and are not currently profitable. Hence, in developing the sugarcane yield prediction model, it might be decided to focus on only the dominant varieties (or cultivars) that contribute significantly to the total harvest.

Sugarcane yield is a function of various factors or effects such as variety (cultivar), age of sugarcane loads at harvest, seasonal conditions, soil type, and/or weather conditions. Weather conditions include rainfall, maximum temperature, difference between maximum and minimum temperature, and/or relative humidity. Seasonal conditions are captured herein using julian date, which is a numerical equivalent of the date. August 1 is julian date 1 and the following July 31 is julian date 365 (or 366 for leap year). However, the selection of August 1 as the reference julian date is arbitrary and is merely used for the sake of illustration of growing conditions in a region such as south India. This reference date can change for the particular country, or its part, which is being modeled, and is based primarily on the weather cycle.

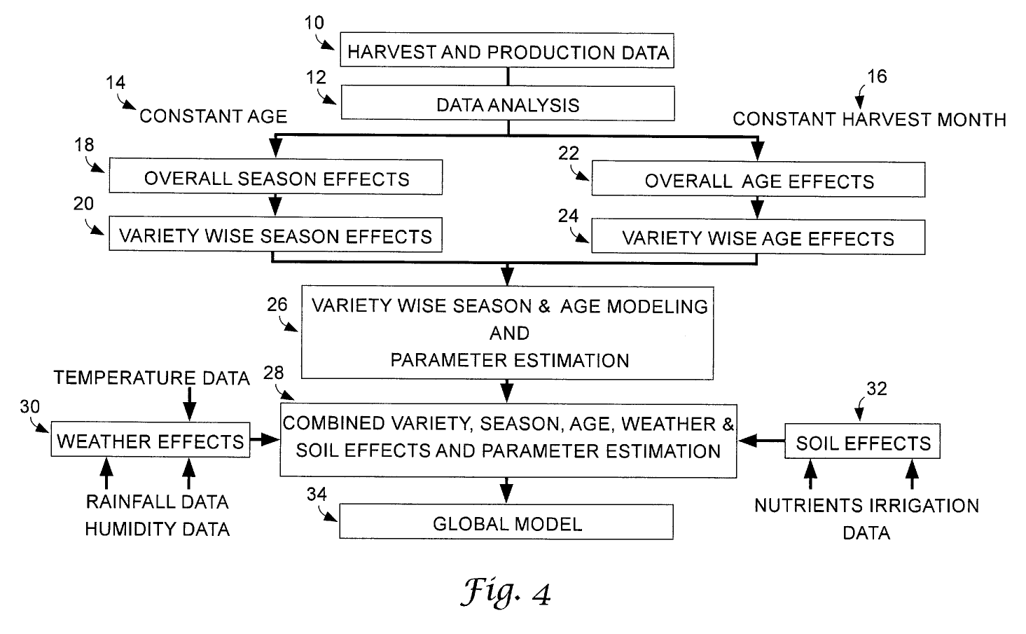

Modeling all desired effects in a single model in one step makes it difficult to determine the contributions or exact relationships between yield and the individual effects. Therefore, an individual approach, for example, may be followed to develop the mathematical formulation (model) for sugarcane yield prediction. This individual modeling approach is shown in FIG. 4.

This individual modeling approach starts with inputting harvest and production training data at a block 10. This data includes data on sugarcane yield by variety, by age, by seasonal date (e.g., Julian Date), and also includes a yield database for other effects such as weather, soil, and/or irrigation conditions. The weather effects, for example, may include the effects of rainfall, maximum temperature, difference between maximum and minimum temperature, and/or relative humidity by actual date.

As is shown in FIG. 4, an analysis of the data provided at 10 is initiated at 12 and proceeds along separate parallel paths 14 and 16, the path 14 being based on seasonal effects on yield with the age of the sugarcane at harvest being kept constant, and the path 16 being based on age effects on yield with the harvesting month being kept constant. In the path 14, the training data is analyzed at 18 to determine the overall seasonal effects on sugarcane yield, and the training data is analyzed at 20 to determine the seasonal effects on sugarcane yield by variety. In the path 16, the training data is analyzed at 22 to determine the overall age effects on sugarcane yield, and the training data is analyzed at 24 to determine the age effects on sugarcane yield by variety.

Based on these analyses, variety wise season and age modeling and parameter estimation are performed at 26 to produce an initial sugarcane yield model. This model is refined at 28 based on weather effects 30 and soil effects 32. As shown in FIG. 4, the weather effects 30 may include the effects of temperature, rainfall, and/or humidity, and the soil effects 32 may include the effects of nutrients and/or irrigation. The result is a global sugarcane yield prediction model 34 that can be used to predict sugarcane yield for future sugarcane harvests in the relevant geography covered by the model.

The equations and associated discussion below illustrate an example of one manner in which the flow of FIG. 4 may be implemented to produce the prediction model 34.

It should be understood from FIG. 4 that individual effects, such as seasonal effects (captured using julian dates), age effects, weather effects, and/or soil effects are modeled independently. This modeling helps in understanding the impact of individual effects on sugarcane yield. The dominant different varieties are also considered for modeling by julian and age effects.

The independent models so obtained for julian date and age effects are then merged together to produce a combined model which considers variety, julian date, and age effects while predicting sugarcane yield. An independent dynamic model is obtained at 28 for weather effects, such as rainfall, maximum and minimum temperature information, and/or relative humidity, on sugarcane yield. The dynamic weather model so obtained will be combined with static combined model for julian date and age effects.

Finally, a soil model is developed considering the soil type of the farm based on soil nutrients and/or irrigation data specific to the farm.

The unified model 34 produced at 28 is obtained in the final step by combining all of the above mentioned effects.

### Modeling Season (Julian Date) Effect

As discussed above, each effect on sugarcane yield is modeled independently of the other effects. As a first step, the seasonal effect on sugarcane yield is captured. The seasonal effect is represented in the form of julian date, although other representations could be used. In order to understand the seasonal effect on sugarcane yield, variations in sugarcane yield are first analyzed. In order to analyze variations in sugarcane yield due to the seasonal effect, the age of the sugarcane is fixed, such as to the 390-400 day range, in order to minimize the age effect on sugarcane yield variations, as indicated by the constant age notation in FIG. 4. As can be seen from FIG. 2, the particular age group of 390-400 days is a dominant age group in the example harvest training data and, therefore, can provide a reasonable data size for analysis. The average sugarcane yields for all varieties (or the dominant varieties) are considered in this analysis.

The same exercise is repeated by considering variety specific data. Generally, it has been found that the trend in the overall sugarcane yield variation with respect to harvest month so as to capture the seasonal effect is substantially the same as the trend in sugarcane yield variations of at least the dominant varieties with respect to harvest month. However, variety wise, the sugarcane yield versus harvest data curves can move up (for a rich sugarcane yield variety) or down (for a poor sugarcane yield variety).

The relationship between the average sugarcane yield and harvest month (expressed in terms of julian date) is generally polynomial in nature. The following equation captures the polynomial relationship between sugarcane yield and julian date:

ŷ_{v,d}^{JD}=α_{v,p}^{y}(JD_{d})^{p}+α_{v,p-1}^{y}(JD_{d})^{p-1}+ . . . +α_{v,l}^{y}(JD_{d})¹+α_{v,0}^{y} (1)

for all v and d, where d represents harvesting day, v represents variety, p represents the order of the polynomial, ŷ_{v,d}^{JD} is a variable representing the predicted sugarcane yield for variety v on day d because of only the julian date effect, α_{v,p}^{y} is a parameter for variety v to model the julian date effect for a polynomial of order p on sugarcane yield, and JD_{d} is a parameter representing Julian Date for harvesting day d.

### Modeling Age Effect

The relationship between the average sugarcane yield and age of the sugarcane is generally quadratic in nature. Typically, sugarcane yield increases with the age of the sugarcane as maturity adds mass to the sugarcane. However, this trend reverses after a certain age, as evaporation dries out the sugarcane mass. This domain understanding also suggests the quadratic relationship between sugarcane yield and its age at harvest.

Further, to confirm this understanding, the variation of average sugarcane yield (considering all the varieties) as function of age of the sugarcane can be studied with the training data. As indicated above, the training data is actual data accumulated with respect to past harvests and is used as described herein to determine the parameters of the sugarcane yield prediction models.

It is important that this variation in average sugarcane yield as a function of age should only be due to the age effect so that the underlying conclusion related to this relationship is unbiased. Therefore, the analysis of the effect of age on sugarcane yield should be carried out for those sugarcane entries which are harvested in the same month of a given year, as indicated by the constant harvest month notation in FIG. 4. This constraint helps to minimize the seasonal and weather effects on this variation. For this analysis, sugarcane load entries harvested in a particular month, such as March of a particular year for example, may be considered. Depending on geography, the month of March is the top harvest month in each year and, therefore, can provide reasonable sized data for the analysis.

The quadratic relationship between sugarcane yield and the age effect is given in the following equation:

ŷv,a^{A}=cᵥ^{y}a²+dᵥ^{y}a+eᵥ^{y} (2)

for all v and a, where a represents age group, cᵥ^{y}, dᵥ^{y}, and eᵥ^{y} are parameters for variety v to model the age effect on sugarcane yield, and ŷ_{v,a}^{A} represents the predicted yield for age a of variety v because of the age effect only. The quadratic nature of age effect on yield of the crop is illustrative only and can be a polynomial of higher order.

### Combined Modeling of Julian Date and Age

Above, the individual seasonal and age effects were modeled separately. Such models are useful for considering the impact analysis of the individual effects. However, to make these models more suited in an optimization framework, they can be combined in order to address both the seasonal and age effects simultaneously. The combined model is given by the following equation:

ŷ_{v,d,a}^{(JD,A)}=ŷ_{v,d}^{JD}+ŷ_{v,a}^{A}+δᵥ^{y} (3)

for all v, d, and a, where ŷ_{v,d,a}^{(JD,A)} is the predicted yield for age a of variety v on day d combining julian date and age effects, ŷ_{v,d}^{JD} is given be equation (1), ŷ_{v,a}^{A} is given be equation (2), and δᵥ^{y} is a bias term for variety v to model the julian and age effects on yield. The individual values of ŷ_{v,d}^{JD} and ŷ_{v,a}^{A} are such that they each are close to the actual yield value of the sugarcane for the given variety, julian date, and age group. Hence, the combined sum of these two terms falls in the range of twice the actual yield value. The bias term δᵥ^{y} adjusts ŷ_{v,d,a}^{(JD,A)} to the realistic range.

Using equations (1) and (2), equation (3) can be expanded as given by the following equation:

ŷ_{v,d,a}^{(JD,A)}=α_{v,p}^{y}(JD_{d})^{p}+α_{v,p-1}^{y}(JD_{d})^{p-1}+ . . . +α_{v,1}^{y}(JD_{d})¹+cᵥ^{y}a²+dᵥ^{y}a+γᵥ^{y} (4)

for all v, d, and a, where

a=d−pd+1 (5)

and γᵥ^{y} is an aggregation of all constant terms as given by the following equation:

γᵥ^{y=α}_{v,0}^{y}+eᵥ^{y}+δᵥ^{y} (6)

for all v.

The model represented by equations (4) and (6) may be fitted to production and harvest training data during the training or modeling phase in order to estimate optimal values for the parameters α_{v,p}^{y} to α_{v,1}^{y}, cᵥ^{y}, dᵥ^{y}, and γᵥ^{y}. The estimation problem is solved as an optimization problem. The optimization problems is stated as an objective function by the following equation:

$${min}_{( {α}_{v , p}^{y} , {α}_{v , p - 1}^{y} , … , {α}_{v , 1}^{y} , {c}_{v}^{y} , {d}_{v}^{y} , {γ}_{v}^{y} )} {\sum }_{n = 1}^{{N}_{E}} {ɛ}_{n}^{abs} \qquad ( 7 )$$

where N_{E} represents the total number of harvest load entries containing the training data (i.e., the size of the data set representing all harvest load entries in the harvest training database). It should be noted that this modeling scheme is more generic and does not fix the sugarcane age and harvest month as was done in connection with equations (1) and (2). The value εₙ^{abs} represents the absolute error between predicted yield and actual yield and is constrained as given by the following inequalities:

εₙ^{abs}≧Yₙ−ŷₙ^{(JD,A)} (8)

εₙ^{abs}≧−(Yₙ−ŷₙ^{(JD,A)}) (9)

for all entries n, and where Yₙ is the actual yield for entry n in the training database, ŷₙ^{(JD,A)} is the predicted yield for harvest load entry n using julian and age effects, and

$${\hat{y}}_{n}^{( JD , A )} = {\sum }_{v = 1}^{{N}_{V}} ( {NV}_{n , v} ) ( {\hat{y}}_{v , {HD}_{n} , {A}_{n}}^{( JD , A )} ) \qquad ( 10 )$$

for all n, and where Nᵥ is the set of varieties, NV_{n,v} is a binary matrix indicating to which variety v harvest load entry n belongs, such that NV_{n,v} is equal to one when the harvest load of entry n belongs to variety v and otherwise is equal to zero, and

$$\begin{matrix} {A}_{n} = ( {HD}_{n} - {PD}_{n} + 1 ) \\ and & ( 11 ) \\ {\hat{y}}_{v , {HD}_{n} , {A}_{n}}^{( JD , A )} = {{α}_{v , p}^{y} ( {JD}_{{HD}_{n}} )}^{p} + {{α}_{v , p - 1}^{y} ( {JD}_{{HD}_{n}} )}^{p - 1} + … + {{α}_{v , 1}^{y} ( {JD}_{{HD}_{n}} )}^{1} + {c}_{v}^{y} {A}_{n}^{2} + {d}_{v}^{y} {A}_{n} + {γ}_{v}^{y} & ( 12 )\end{matrix}$$

for all v, where Aₙ is a parameter indicating the age of the harvest entry n at harvest, HDₙ is a parameter indicating the harvest date of harvest entry n, PDₙ is a parameter indicating the planting date of harvest entry n, ŷ_{v,HD}_{ₙ}_{,A}_{ₙ}^{(JD,A)} is the season and age dependent yield for variety v on harvest date HD at age A in entry n, and JD_{HD}_{ₙ} represents the harvest date HD in entry n in terms of julian date. It should be noted that εₙ^{abs} always stores the positive difference between Yₙ and ŷₙ^{(JD,A)}. However, to make the linear programming (LP) relaxation of the constraints given by equations (8) and (9) tight, the following constraint is included into the optimization problem:

εₙ^{abs ≦Y}ₙ (13)

for all n.

A few additional linear programming tightening constraints obtained by using the domain knowledge about the relationship between age and yield are given as follows:

Yₙ−5≦ŷₙ^{(JD,A)}≦Yₙ+3 ∀n,∀(Aₙ≦340 or Aₙ≧440) (14)

Yₙ−3≦ŷₙ^{(JD,A)}≦Yₙ+5 ∀n,∀(Aₙ=341, . . . ,439) (15)

The numbers 3, 5, 340, and 440 are illustrative only and may change depending on geography and the training data selected for creating the models described herein.

It should be noted that the constraints given by equations (13) to (15) are optional constraints. However, these constraints help make the optimization search space more compact. The following additional constraints may be imposed:

α_{v,p}^{y}^{^{low}}≦α_{v,p}^{y}≦α_{v,p}^{y}^{^{high}} (16)

cᵥ^{y}^{^{low}}≦Cᵥ^{y}≦cᵥ^{y}^{^{high}} (17)

dᵥ^{y}^{^{low ≦d}}ᵥ^{y}≦dᵥ^{y}^{^{high}} (18)

γᵥ^{y}^{^{log}}≦γᵥ^{y}≦γᵥ^{y}^{^{high}} (19)

for all v and p. The upper and lower bounds on the above parameters in equations (16) to (19) can be obtained using the results from modeling the julian date and age effects separately. It should be noted that these ranges on parameters are very specific to the training data used for modeling and need to be pre-estimated for other industries' harvest data, as sugarcane is a weather sensitive crop. The linear optimization problem with objective function given by equation (7) and subjected to constraints given by equations (8)-(19) is solved to estimate the optimal values for the parameters.

Once the optimal parameter values are computed, the residual error is calculated according to the following equation:

errₙ=Yₙ−ŷₙ^{(JD,A)} (20)

for all n. Assuming that a residual analysis is tabulated using a set of training data, it will be apparent that there can be significant modeling errors in the combined (julian and age) model predictions and that additional variables like weather and/or soil effects need to be considered to improve the model and thereby the quality of predictions.

### Modeling Weather Effect

As discussed earlier, sugarcane yield is influenced by stochastic effects like weather and/or soil conditions. The weather effect is highly complex and poorly characterized in practice. It comprises rainfall, temperature, humidity, wind, and/or sunshine related effects. These individual effects have a dynamic impact on sugarcane yield. For example, sugarcane yield is dependent on the pattern of rainfall on the sugarcane crop throughout its lifetime. Therefore, weather related effects should be modeled within a dynamic framework.

The weather model captures significant amount of residual error errₙ (of the combined model of julian date and age effects) using weather information such as rainfall, maximum temperature, and the difference between maximum and minimum temperatures (delta temperature). Although only temperature and rainfall data are used herein to model weather effects, the weather model, in general, can be more generic, comprising other variables such as humidity, sunshine hours, etc.

It may be assumed that the yield contribution due to weather related effects on harvest day d in planting zone z is denoted as ŷ_{d,z}^{W}. As can be seen, the weather contribution factor is a function of the harvest date (d) of the sugarcane crop. Once the harvest date of the crop is known, the related weather information experienced by the sugarcane crop prior to harvest can be computed and put in the model. The yield contribution ŷ_{d,z}^{W} can be modeled in accordance with the following equation:

ŷ_{d,z}^{W}=ŷ_{d,z}^{RF}+ŷ_{d,z}^{MT}+ŷ_{d,z}^{ΔT} (21)

for all d and z. The first term on the right hand side of equation (21) is the rain fall (RF) model that considers past rainfall information (such as rainfall in the last eight months), while the second and last right hand terms indicate dynamic models for maximum and delta temperatures which consider past temperature effects (such as temperature effects in the last six months). Equation (21) also expresses weather variation across different planting zones z.

### Modeling Rainfall Effect

The rainfall model is dynamic in nature and can comprise, for example, two terms as given in the following equation:

ŷ_{d,z}^{RF}=ŷ_{d,z}^{RF}^{₁₀}+ŷ_{d,z}^{RF}^{₃₀} (22)

for all d and z.

The first term ŷ_{d,z}^{RF}^{₁₀} captures the effect on yield due to the rainfall effect on harvest day d in zone z over the last two months in 6 groups of 10 days each, as given by the following equation:

$${\hat{y}}_{d , z}^{{RF}_{10}} = ( {\sum }_{i = 1}^{6} {rf}_{i}^{y} ) ( {\sum }_{m = 1}^{10} ( {RF}_{d - 10 ( i - 1 ) - m , z} ) ) \qquad ( 23 )$$

for all d and z, where rfᵢ^{y} is a parameter useful in modeling the rainfall effect on yield, and RF_{d,z} is the rainfall on day d in zone z. The groupings used in equation (23) may be different in number and size. There are six rainfall parameters rfᵢ^{y} in equation (23), which will be determined while predicting the effect on yield of rainfall over the last two months (in slots of 10 days each).

The second term in equation (22) captures the effect of rainfall during the last 61 to 240 days in groups of 30 days. Hence, there are six distinct groups. This second term is given by the following equation:

$${\hat{y}}_{d , z}^{{RF}_{30}} = ( {\sum }_{i = 1}^{6} {rf}_{i + 6}^{y} ) ( {\sum }_{m = 1}^{30} ( {RF}_{d - 30 ( i + 1 ) - m , z} ) ) \qquad ( 24 )$$

for all d and z. The groupings used in equation (24) also may be different in number and size.

Hence, equations (23) and (24) over a past period of time (such as 8 months) consider the rainfall effect on yield. There are a total of twelve parameters rfᵢ^{y} in the dynamic rainfall model of equations (23) and (24) to predict the effect of rainfall on yield.

### Modeling Maximum Temperature Effect

The model to predict the effect of maximum temperature on yield is given by way of example by the following equation:

ŷ_{d,z}^{MT}=y_{d,z}^{MT}^{₁₀}+ŷ3 _{d,z}^{MT}^{₃₀} (25)

for all d and z, where ŷ_{d,z}^{MT} is the maximum temperature dependent yield on day d in zone z.

The first term ŷ_{d,z}^{MT}^{₁₀} captures the effect on yield due to the maximum temperature effect on harvest day d in zone z over the last two months in ten day slots as given by the following equation:

$${\hat{y}}_{d , z}^{{MT}_{10}} = ( {\sum }_{i = 1}^{6} {mt}_{i}^{y} ) ( {\sum }_{m = 1}^{10} {MT}_{d - 10 ( i - 1 ) - m , z} ) \qquad ( 26 )$$

for all d and z, and where mtᵢ^{y} are parameters to model the effect of maximum temperature on yield, and MT_{d,z} is the maximum temperature in zone z on day d.

The second term ŷ_{d,z}^{MT}^{₃₀} considers the effect on yield of the maximum temperature in the remaining four months (out of the last six months) in thirty days slots as given by the following equation:

$${\hat{y}}_{d , z}^{{MT}_{30}} = ( {\sum }_{i = 1}^{4} {mt}_{i + 6}^{y} ) ( {\sum }_{m = 1}^{30} {MT}_{d - 30 ( i + 1 ) - m , z} ) \qquad ( 27 )$$

for all d and z.

Hence, there are in total 10 parameters mtᵢ^{y} (six from equation (26) and four from equation (27)) in dynamically modeling the effect of maximum temperature on yield prediction. The groupings used in equation (26) and (27) also may be different in number and size.

### Modeling Delta Temperature Effect

The dynamic model to capture the effect of delta temperature on yield is very similar to that used for modeling the maximum temperatures effect. Hence, the dynamic model to capture the effect of delta temperature on yield is given by the following equation:

ŷ_{d,z}^{ΔT}=ŷ_{d,z}^{ΔT}^{₁₀}+ŷ_{d,z}^{ΔT}^{₃₀} (28)

for all d and z.

The first term ŷ_{d,z}^{ΔT}^{₁₀} captures the effect on yield due to the difference effect between maximum and minimum temperatures on harvest day d in zone z over the last two months in ten day slots as given by the following equation:

$${\hat{y}}_{d , z}^{Δ {T}_{10}} = ( {\sum }_{i = 1}^{6} δ {t}_{i}^{y} ) ( {\sum }_{m = 1}^{10} Δ {T}_{d - 10 ( i - 1 ) - m , z} ) \qquad ( 29 )$$

for all d and z, and where δtᵢ^{y} are parameters to model the effect of temperature difference on yield, and ΔT_{d,z} is the temperature difference in zone z on day d.

The second term ŷ_{d,z}^{ΔT}^{₃₀} considers the effect on yield of the temperature difference in the remaining four months (out of the last six months) in thirty days slots as given by the following equation:

$${\hat{y}}_{d , z}^{Δ {T}_{30}} = ( {\sum }_{i = 1}^{4} δ {t}_{i + 6}^{y} ) ( {\sum }_{m = 1}^{10} Δ {T}_{d - 30 ( i + 1 ) - m , z} ) \qquad ( 30 )$$

for all d and z.

Hence, there are in total 10 parameters δtᵢ^{y} (six from equation (29) and four from equation (30)) in dynamically modeling the effect of delta temperature on yield prediction. The groupings used in equation (29) and (30) also may be different in number and size.

The combined dynamic model to predict the effect of weather conditions on yield is comprising of a total 32 parameters (12 for rainfall and 10 each for maximum temperature and delta temperature). The weather model represented by equations (21) to (30) is variety independent. In other words, it assumes that all the varieties show similar sensitivity to weather conditions. However, it is straight forward to develop a weather model that considers variety dependency in a similar manner.

### Modeling Combined Effects of Julian Date, Age and Weather

The weather model of equation (21) is merged with the combined model of the effects of julian date and age, and the optimal values for all parameters (julian date, age, and weather model parameters) of the global model are obtained using an optimization framework. This combined model is given by the following equation:

$${\hat{y}}_{n}^{( JD , A , W )} = {\hat{y}}_{n}^{( JD , A )} + {\sum }_{z = 1}^{{N}_{Z}} ( {NZ}_{n , z} ) ( {\hat{y}}_{d , z}^{W} ) \qquad ( 31 )$$

for all harvest load entries n in the training database, where ŷₙ^{(JD,A,W)} is the predicted yield of harvest load entry n using the julian date, age, and weather effects, N_{z} is the set of all zones, and NZ_{n,z} is a binary matrix indicating to which zone z farm a harvest load entry n belongs.

The linear optimization problem presented by the objective function given by equation (7) is solved, using the sample training data to estimate the optimal values for all parameters, by subjecting the objective function to the constraints given by equations (8)-(19), by replacing ŷₙ^{(JD,A)} with ŷₙ^{(JD,A,W)} and by replacing equation (10) with the following equation:

$${\hat{y}}_{n}^{( JD , A , W )} = {\sum }_{v = 1}^{{N}_{V}} ( {NV}_{n , v} ) ( {\hat{y}}_{v , {HD}_{n} , {A}_{n}}^{( JD , A )} ) + {\sum }_{z = 1}^{{N}_{Z}} ( {NZ}_{n , z} ) ( {\hat{y}}_{d , z}^{W} ) \qquad ( 32 )$$

for all n.

Once the optimal parameter values are computed as described above, the residual error is calculated in accordance with the following equation:

errₙ=Yₙ−ŷₙ^{(JD,A,W)} (33)

for all n. Assuming that a residual analysis is tabulated using the set of training data, it will be apparent that there can be modeling errors in the combined (julian and age and weather) model predictions and that an additional variable for soil effects can be considered to improve the model and thereby the quality of predictions.

### Modeling Soil and Irrigation Effects

The sugarcane yield of a farm will naturally depend on its soil quality, irrigation, and farming practices adopted by the farmer. Soil quality represents the quantum of nutrients (like Nitrogen (N), Phosphorous (P), Potassium (K), etc.) available in the soil. Irrigation practices represent the availability of water for the farm field. Farming practices are related to the practices adopted by the farmer at various stages, varying from seed sowing to crop harvest, and include, for example, seed quality, sowing and harvesting methods, fertilizers, pesticides, etc.

Based on these practices, the training data relating to sugarcane yields can be classified into a number of different zones using a sample sugarcane variety of fixed age and fixed harvest month. It can be concluded from such training data that the selected zones represent a gross level classification of soil types. In a zone, various kinds of sugarcane yields can be produced. These variations are related to different farming and irrigation practices.

Training data will show that soil, farming, and irrigation related effects are difficult to quantify and are complex in nature. Therefore, these effects can be modeled in a rule based manner. Based on soil, farming, and irrigation training data, the soil effects can be ranked from rich soil to poor soil. Rich soil indicates an improved sugarcane yield over the average sugarcane yield predicted by the above models, and poor soil indicates sugarcane yield that is under the average sugarcane yield.

The gradations can be made with ranks varying from, for example, one to ten, where one indicates poor quality sugarcane yield (adverse soil and related effects) and ten represents the best possible sugarcane yield (favorable soil and related effects).

Corresponding to each soil rank, a contribution factor is assigned so as to amend the above models in accordance with the following equation:

ŷₙ=ŷₙ^{(JD,A,W)}+ŷₙ^{S} (34)

for all n, where ŷₙ^{S} predicts the sugarcane yield contribution due to soil effects for harvest load entry n, and where

$${\hat{y}}_{n}^{S} = {\sum }_{st = 1}^{{N}_{ST}} ( {NS}_{n , st} ) ( {δ}_{v , st}^{S} ) \qquad ( 35 )$$

for all n, where N_{ST} is the set of all soil types, NS_{n,st} is a binary matrix indicating to which soil type st the farm of load entry n belongs and which is equal to one when the soil of the farm corresponding to entry n belongs to soil type st and is otherwise zero, and δ_{v,st}^{S} is the sugarcane yield contribution factor of variety v for soil type st (representing soil and irrigation effects). Because the soil and irrigation effect related contribution factor δ_{v,st}^{S} is dependent on the farm and plant variety, different values of the contribution factor can be obtained for the same farm but planted with different varieties. Optimal values of δ_{v,st}^{S} can be obtained using soil nutrients, irrigation, and farming practice related data of a field (i.e. domain knowledge), or can be obtained using optimization techniques.

### The Unified Model for Yield Prediction

The soil model can be combined with the combined julian, age, and weather model. Hence the linear optimization problem with the objective function given by equation (7) and the constraints given by equations (8)-(19) is given by the following equations:

$$\begin{matrix}{min}_{( {α}_{v , p}^{y} , {α}_{v , p - 1}^{y} , … , {α}_{v , 1}^{y} , {c}_{v}^{y} , {d}_{v}^{y} , {γ}_{v}^{y} , {rf}_{i : 1 … 12}^{y} , {mt}_{i : 1 … 10}^{y} , δ {t}_{i : 1 … 10}^{y} , {δ}_{v , st}^{S} )} {\sum }_{n = 1}^{{N}_{E}} {ɛ}_{n}^{abs} & ( 36 ) \\ {ɛ}_{n}^{abs} \geq {Y}_{n} - {\hat{y}}_{n} & ( 37 ) \\ {ɛ}_{n}^{abs} \geq - ( {Y}_{n} - {\hat{y}}_{n} ) & ( 38 )\end{matrix}$$

for all n, and where the unified model is give by the following equation:

$${\hat{y}}_{n} = {\sum }_{v = 1}^{{N}_{V}} ( {NV}_{n , v} ) ( {\hat{y}}_{v , {HD}_{n} , {A}_{n}}^{( JD , A )} ) + {\sum }_{z = 1}^{{N}_{Z}} ( {NZ}_{n , z} ) ( {\hat{y}}_{d , z}^{W} ) + {\sum }_{st = 1}^{{N}_{ST}} ( {NS}_{n , st} ) ( {δ}_{v , st}^{S} ) \qquad ( 39 )$$

for all n.

The set of constraints still include the constraints given by equations (11)-(19) along with the parameter ranges calculated as discussed above. When the unified model (aggregating all effects) is applied on the sample harvest and production data during training, the non-modeled variation (the error between predicted and actual sugarcane yield) has fallen below reasonable limits. It is concluded that the unified model, comprising julian date, age, weather, and soil related effects, accurately predicts sugarcane yield. The non modeled variation after unified model is attributed to complex effects such as plant diseases, sun shine hours, etc.

### Unstructured Modeling of Sugarcane Yield

As indicated above, the relationship between sugarcane yield, age at harvest, and harvest date (defining the seasonal effects) was developed by applying structured models. The relationship between sugarcane yield and its age at harvest was assumed to be a second order polynomial relationship, and the relationship between sugarcane yield and harvest julian date was assumed to be a polynomial relationship of order p. However, in actual practice, the order of the polynomial relationship may not be known a priori. Moreover, it may not be a good practice to assume a very high polynomial order because such an assumption may lead to data over fitting. These drawbacks can be addressed by assuming an unstructured yield model rather than the structured polynomial yield model discussed above.

For example, the structured yield model taking in account the effects of julian date and age, ignoring the bias term, is derived from equation (3) and is given by the following equation:

ŷ_{v,d,a}^{(JD,A)}=ŷ_{v,d}^{JD}+ŷ_{v,a}^{A} (40)

for all v, d, and a.

For an unstructured yield model, the age effect captured by the term ŷ_{v,a}^{A} in the model of equation (4) can be replaced by an unstructured age effect model given by an age term δ_{v,a}^{A}. The age term δ_{v,a}^{A} indicates the deviation from nominal yield of variety v of age a. The nominal yield value is for a particular harvest age (such as of 300 days) and can be different for different harvest dates as indicated by a julian date term η_{v,d}^{JD} indicating the nominal yield of variety v on harvest day d. The nominal yield value η_{v,d}^{JD} captures the seasonal (julian date) effects in an unstructured way. It should be noted that the term δ_{v,a}^{A} can take on negative values. The unstructured model given by the following equation results:

ŷ_{v,d,a}^{(JD,A)}=η_{v,d}^{JD}+δ_{v,a}^{A} (41)

for all v, d, and a.

The advantage of the above modeling representation is that the order of the model polynomial is not required to be known a priori. Instead, the data guides the nature of the relationship. In order to compute the optimal values of η_{v,d}^{JD} and δ_{v,a}^{A} in equation (41), the following optimization equation can be used:

$${min}_{( {η}_{v , d}^{JD} , {δ}_{v , a}^{A} )} {\sum }_{v = 1}^{{N}_{V}} {\sum }_{d = 1}^{{N}_{D}} {\sum }_{a = 1}^{{N}_{A}} ( {NE}_{v , d , a} ) ( {ɛ}_{v , d , a}^{abs} ) \qquad ( 42 )$$

for all v, d, and a, where N_{A} is the set of all age groups, NE_{v,d,a} is the number of entries in the training data for variety v on day d for age group a. The following equation expresses the relationship between NE_{v,d,a} and N_{E}:

$${\sum }_{v = 1}^{{N}_{V}} {\sum }_{d = 1}^{{N}_{D}} {\sum }_{a = 1}^{{N}_{A}} ( {NE}_{v , d , a} ) = {N}_{E} \qquad ( 43 )$$

The error ε_{v,d,a}^{abs} is the difference between the average yield Y̅_{v,d,a} for the entries given by NE_{v,d,a} and the predicted yield ŷ_{v,d,a}^{(JD,A)} given by equation (41). Hence, the error ε_{v,d,a}^{abs} may be constrained as given the following inequalities:

$$\begin{matrix}{ɛ}_{v , d , a}^{abs} \geq {\overline{Y}}_{v , d , a} - {\hat{y}}_{v , d , a}^{( JD , A )} & ( 44 ) \\ {ɛ}_{v , d , a}^{abs} \geq - ( {\overline{Y}}_{v , d , a} - {\hat{y}}_{v , d , a}^{( JD , A )} ) & ( 45 )\end{matrix}$$

for all v, d, and a.

The deviation in yield from its nominal value as indicated by δ_{v,a}^{A} in equation (41) may be bounded as follows:

Δ̅Y̅_{v,a}^{A}−1.5≦δ_{v,a}^{A}≦ Δ̅Y̅_{v,a}^{A}+1.5 (46)

where Δ̅Y̅_{v,a}^{A} indicate the actual deviation that is obtained when average yield for individual varieties is plotted against age. The deviation may be assumed to be from the average yield value at a particular harvest age, such as 300 days. The numbers 1.5 are illustrative only and may change depending on geography and the training data selected for creating the models described herein.

The predicted average yield {circumflex over ( y̅_{v,d} for each variety v on each harvest day d is calculated using following equation:

$${\hat{\overline{y}}}_{v , d} = \frac{{\sum }_{a = 1}^{{N}_{A}} ( {\hat{y}}_{v , d , a}^{( JD , A )} ) ( {AE}_{v , d , a} )}{{\sum }_{a = 1}^{{N}_{A}} {AE}_{v , d , a}} \qquad ( 47 )$$

for all v and d, where AE_{v,d,a} represents the total area of the loads of variety v harvested on day d for an age range given by group a. In other words, it is the total area of the entries given by NE_{v,d,a}. These predicted average yield values given by {circumflex over ( y̅_{v,d} may be bounded in accordance with the following constraints:

(0.85)( Y̅_{v,d}^{JD})≦{circumflex over ( y̅_{v,d}≦(1.15)( Y̅_{v,d}^{JD}) (48)

for all v and d, where Y̅_{v,d}^{JD} is the actual average yield of a load of variety v harvested on day d. The numbers 0.85 and 1.15 are illustrative only and may change depending on geography and the training data selected for creating the models described herein.

The optimization problem given by equations (41)-(48) and the objective function given by equation (42) is solved using the training data in order to determine the optimal values for η_{v,d}^{JD} and δ_{v,a}^{A}. Once the model for the predicted yield ŷ_{v,d,a}^{(JD,A)} is established using this approach, the weather and soil model can be combined in the same manner as described above to obtain the unified model.

Thus, the unified model may be used to predict the yield trends for the dominant crop varieties. The yield trends representing the relationship between average predicted yield as a function of harvest age or harvest month are of special interest for validating the results with the domain knowledge. This analysis will also help in understanding the relative ranking of the varieties with respect to sugarcane yield. The unified model so developed being modular in nature can be utilized for understanding the relative contributions of age and seasonal effects on the yield of a given variety.

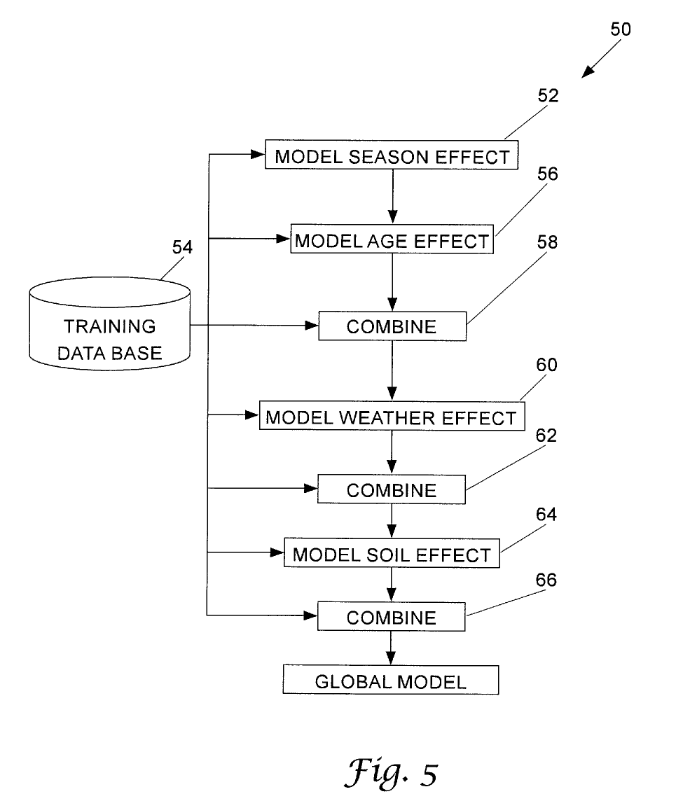

FIG. 5 is a flow chart of another program 50 that may be executed by a computer in order to produce the models as described above during the training stage.

According to the program 50, the effects on yield of the harvest season are modeled at 52 in accordance with equation (1) and the training data relating yield to plant variety and harvest date stored in a database 54. Also, the effects on yield due to age of the crop at the time of harvest are modeled at 56 in accordance with equation (2) and the training data relating yield to plant variety and age stored in the database 54. These models produced at 52 and 56 are combined at 58 in accordance with equations (3)-(20) to produce a model that is capable of predicting yield based on the effects of harvest season and crop age at harvest.

As indicated above, the modeling performed at 52, 56, and 58 is based on a structured representation of the season and age effects on yield and, in particular, a polynomial representation of the season and age effects. Alternatively, the modeling performed at 52, 56, and 58 can instead be based on an unstructured yield model rather than a structured yield model. Accordingly, the modeling performed at 52, 56, and 58 can instead be based on equations (41)-(48).

The combined model (structured or unstructured) produced at 58 fails to capture other effects on yield. Accordingly, at 60, the effects of weather on yield are modeled in accordance with equations (21)-(30) and the training data relating yield to harvest date and zone stored in the database 54. At 62, the model produced at 60 is combined at 58 with the combined model produced at 58 in accordance with equations (31)-(33) to produce a model that is capable of predicting yield based on the effects of harvest season, crop age, and weather.

The combined model produced at 62 may still fail to capture other effects on yield. Accordingly, at 64, the effects of soil on yield are modeled in accordance with equations (34) (35) and the training data relating yield to soil type and plant variety stored in the database 54. The model produced at 64 is combined at 66 with the combined model produced at 62 in accordance with equations (36)-(39) to produce a global model that is capable of predicting yield based on the effects of harvest season, crop age, weather, and soil conditions.

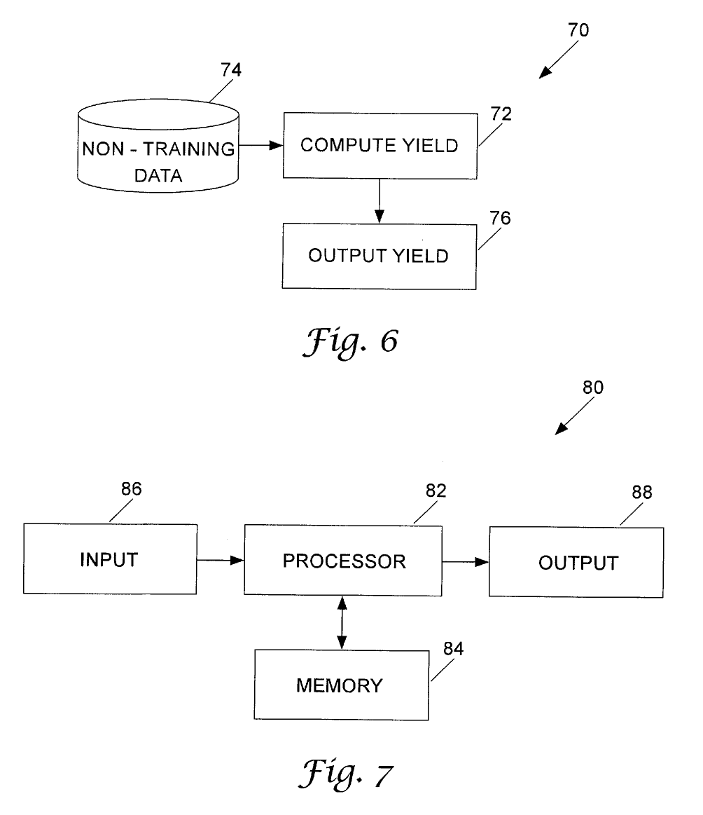

FIG. 6 is a flow chart representing a program 70 that can be executed by a computer for predicting sugarcane yield from sugarcane crops during the use stage. At a block 72, the program 70 computes the sugarcane yield ŷ_{n,d} for a harvesting day d in accordance with any of the models ŷ_{v,d}^{JD}, ŷ_{v,d}^{A}, ŷ_{d,z}^{W}, or ŷ_{v,st}^{S}, or any combinations of these models based on planting and weather data accumulated in a database 74 throughout the current growing season. At a block 76, the program 70 outputs the sugarcane yield ŷ_{n,d} for use by a user who determines whether this sugarcane yield is sufficient to trigger harvesting. If not, the user may repeat this program for a different harvest day. The index n represents farm identity.

The program corresponding to the flow charts of FIG. 4, FIG. 5, and/or FIG. 6 can be executed in connection with a computer 80 shown in FIG. 7. The computer 80 includes a processor 82, a memory 84, an input device(s) 86, and an output device(s) 88. If the computer 80 is used for model development, the training data is input to the computer 80 by the input device 86 and is stored in the memory 84. The program corresponding to the flow chart of FIG. 4 or FIG. 5 is also stored in the memory 84 and is executed by the processor 82 in order to generate the appropriate model as discussed above. If the computer 80 is used for yield prediction, the non-training data is input to the computer 80 by the input device 86 and is stored in the memory 84. The program corresponding to the flow chart of FIG. 6 is also stored in the memory 84 and is executed by the processor 82 in order to predict yield as discussed above.

Certain modifications of the present invention have been discussed above. Other modifications of the present invention will occur to those practicing in the art of the present invention. For example, the present invention has been described above in connection with sugarcane crops. However, the present invention could be used in connection with other crop classes. Further to this example, included within the crop classes for which the above described yield prediction can be of benefit are crop classes that have the property of synchronized group maturity. The term “synchronized group maturity” indicates a similar perceivable growth (vegetative or non-vegetative) level at any point of time within and across the crop entities planted simultaneously within a defined geographical territory for the crop classes. Such crop classes may include, for example, wheat, rice, oil seed, etc.

As another example, the order in which seasonal, age, weather, and/or soil effects on yield are modeled may be varied.

As still another example, those who are skilled in the area will recognize that various models have been disclosed above using a polynomial function for the season effect and a quadratic function for the age effect. However, the season effect can be captured using linear functions or non-linear functions such as exponential, logarithm, etc. Similarly, the age effect can be captured by using polynomial, linear, or non-linear functions.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A method implemented by a computer for generating a crop yield prediction model for predicting yield of a crop, the method comprising:
generating a first structured model that models a first dependent effect on the yield of the crop, wherein the first dependent effect comprises a season dependent effect;
generating a second structured model that models a second dependent effect on the yield of the crop, wherein the second dependent effect comprises an age dependent effect;
combining the first and second structured models; and,
determining parameters for the first and second structured models based on training data relating yield to plant variety, harvesting season, and age at harvest.

2. The method of claim 1 further comprising:
generating a third model that models a third dependent effect on the yield of the crop, wherein the third dependent effect comprises an effect other than the season dependent effect and the age dependent effect;
combining the first and second structured models and the third model; and,
determining parameters for the third model based on the training data.

3. The method of claim 1 further comprising:
generating a third model that models a third dependent effect on the yield of the crop, wherein the third dependent effect comprises a weather dependent effect;
combining the first and second structured models and the third model; and,
determining parameters for the third model based on the training data relating yield to plant variety, harvesting season, age at harvest, and weather conditions during growing and/or harvesting, wherein weather conditions include at least one of temperature, rainfall, humidity, and sunshine.

4. The method of claim 1 further comprising:
generating a third model that models a third dependent effect on the yield of the crop, wherein the third dependent effect comprises a soil dependent effect;
combining the first and second structured models and the third model; and,
determining parameters for the third model based on the training data relating yield to plant variety, harvesting season, age at harvest, and soil conditions during growing and/or harvesting, wherein soil conditions include at least one of soil type, irrigation practice, and soil nutrients.

5. The method of claim 1 wherein the training data includes actual yield, and wherein the determining of parameters for the first and second structured models comprises optimizing the parameters by minimizing an error between predicted yield predicted by the first and second structured models and the actual yield.

6. The method of claim 1 where the first structured model comprises a first linear model, and wherein the second structured model comprises a second linear model.

7. The method of claim 1 wherein the first structured model comprises a first non-linear model, and wherein the second structured model comprises a second non-linear model.

8. A method implemented by a computer for generating a crop yield prediction model for predicting yield of a crop, the method comprising:
generating a first unstructured model that models a first dependent effect on the yield of the crop, wherein the first dependent effect comprises a season dependent effect;
generating a second unstructured model that models a second dependent effect on the yield of the crop, wherein the second dependent effect comprises an age dependent effect;
combining the first and second unstructured models; and,
determining parameters for the first and second unstructured models based on training data relating yield to plant variety, harvesting season, and age at harvest.

9. The method of claim 8 further comprising:
generating a third model that models a third dependent effect on the yield of the crop, wherein the third dependent effect comprises an effect other than the season dependent effect and the age dependent effect;
combining the first and second unstructured models and the third model; and,
determining parameters for the third model based on the training data.

10. The method of claim 8 further comprising:
generating a third model that models a third dependent effect on the yield of the crop, wherein the third dependent effect comprises a weather dependent effect;
combining the first and second unstructured models and the third model; and,
determining parameters for the third model based on the training data relating yield to plant variety, harvesting season, age at harvest, and weather conditions during growing and/or harvesting, wherein weather conditions include at least one of temperature, rainfall, humidity, and sunshine.

11. The method of claim 8 further comprising:
generating a third model that models a third dependent effect on the yield of the crop, wherein the third dependent effect comprises a soil dependent effect;
combining the first and second unstructured models and the third model; and,
determining parameters for the third model based on the training data relating yield to plant variety, harvesting season, age at harvest, and soil conditions during growing and/or harvesting, wherein soil conditions include at least one of soil type, irrigation practice, and soil nutrients.

12. The method of claim 8 further comprising:
generating a third model that models a third dependent effect on the yield of the crop, wherein the third dependent effect comprises a weather dependent effect;
generating a fourth model that models a fourth dependent effect on the yield of the crop, wherein the fourth dependent effect comprises a soil dependent effect;
combining the first and second unstructured models and the third and fourth models; and,
determining parameters for the fourth model based on the training data relating yield to plant variety, harvesting season, age at harvest, and soil conditions during growing and/or harvesting.

13. The method of claim 8 wherein the training data includes actual yield, and wherein the determining of parameters for the first and second unstructured models comprises optimizing the parameters by minimizing an error between predicted yield predicted by the first and second unstructured models and the actual yield.

14. A method implemented by a computer of indicating yield of a crop comprising:
predicting the yield of the crop assuming that the crop is harvested on day d based on season and age data corresponding to the crop, wherein the predicting is performed based on a combination of first and second structured models, wherein the first structured model models a first dependent effect on the yield of the crop, wherein the first dependent effect comprises a season dependent effects, wherein the second structured model models a second dependent effect on the yield of the crop, and wherein the second dependent effect comprises an age dependent effect; and,
providing the yield of the crop as an output of the computer implemented method.

15. The method of claim 14 wherein the predicting is performed based on a combination of the first and second structured models and a third model, wherein the third model models a third dependent effect on the yield of the crop, and wherein the third dependent effect comprises an effect other than the season dependent effect and the age dependent effect.

16. The method of claim 14 wherein the predicting is performed based on a combination of the first and second structured models and a third model, wherein the third model models a third dependent effect on the yield of the crop, and wherein the third dependent effect comprises a weather dependent effect.

17. The method of claim 14 wherein the predicting is performed based on a combination of the first and second structured models and a third model, wherein the third model models a third dependent effect on the yield of the crop, and wherein the third dependent effect comprises a soil dependent effect.

18. The method of claim 14 where the first structured model comprises a first linear model, and wherein the second structured model comprises a second linear model.

19. The method of claim 14 wherein the first structured model comprises a first non-linear model, and wherein the second structured model comprises a second non-linear model.

20. The method of claim 14 wherein one of the first and second structured models comprises a linear model, and wherein the other of the first and second structured models comprises a non-linear model.

21. A method implemented by a computer of indicating yield of a crop comprising:
predicting the yield of the crop assuming that the crop is harvested on day d based on season and age data corresponding to the crop, wherein the predicting is performed based on a combination of first and second unstructured models, wherein the first unstructured model models a first dependent effect on the yield of the crop, wherein the first dependent effect comprises a season dependent effect, wherein the second unstructured model models a second dependent effect on the yield of the crop, and wherein the second dependent effect comprises an age dependent effect; and,
providing the yield of the crop as an output of the computer implemented method.

22. The method of claim 21 wherein the predicting is performed based on a combination of the first and second unstructured models and a third model, wherein the third model models a third dependent effect on the yield of the crop, and wherein the third dependent effect comprises an effect other than the season dependent effect and the age dependent effect.

23. The method of claim 21 wherein the predicting is performed based on a combination of the first and second unstructured models and a third model, wherein the third model models a third dependent effect on the yield of the crop, and wherein the third dependent effect comprises a weather dependent effect.

24. The method of claim 21 wherein the predicting is performed based on a combination of the first and second structured models and a third model, wherein the third model models a third dependent effect on the yield of the crop, and wherein the third dependent effect comprises a soil dependent effect.

25. The method of claim 21 wherein the predicting is performed based on a combination of the first and second unstructured models and third and fourth models, wherein the third model models a third dependent effect on the yield of the crop, and wherein the third dependent effect comprises a weather dependent effect, wherein the fourth model models a fourth dependent effect on the yield of the crop, and wherein the fourth dependent effect comprises a soil dependent effect.
